(19) United States
(12) Patent Application Publication
(10) Pub. No.: US 2009/0328079 A1
(43) Pub. Date: Dec. 31, 2009

(54) SPACE SEPARATION FOR A LIBRARY BASED RECORD AND REPLAY TOOL

(75) Inventors: Zhenyu Guo, Beijing (CN); Xuezheng Liu, Beijing (CN); Zheng Zhang, Beijing (CN)

Correspondence Address: LEE & HAYES, PLLC, 601 W. RIVERSIDE AVENUE, SUITE 1400, SPOKANE, WA, 99201, US

(73) Assignee: Microsoft Corportion, Redmond, WA (US)

(21) Appl. No.: 12/163,306

(22) Filed: Jun. 27, 2008

(51) Int. Cl. G06F 9/54

(52) U.S. Cl. 719/328

(57) ABSTRACT

Techniques for separating application processes into a system space and a replay space are described in a record and replay tool. The technique permits applications to run in the replay space while a record and replay library runs and manages resources in system space ensuring accurate replay of saved data that are used by applications.

### CROSS REFERENCES TO RELATED APPLICATIONS

The present application is related to commonly assigned co-pending U.S. patent application Ser. No. ______, Attorney Docket Number MS1-3681US, entitled, “Annotation-Aided Code Generation in Library-Based Replay”, to Guo et al., filed on ______, which is incorporated by reference herein for all that it teaches and discloses.

### BACKGROUND

Modern computing environments are typically multi-threaded, employ advanced features such as asynchronous input/output, and often exist in a distributed environment. Traditional cyclic debugging processes struggle with such a complex environment and, as a result, the environment has become increasingly challenging for developers to debug.

One existing solution for de-bugging such a computing environment is a technique referred to as deterministic replay. Deterministic replay is a powerful approach for de-bugging multi-threaded and distributed applications. Deterministic replay can bring together all relevant states spread across numerous machines in a distributed system, removing non-determinism, and thus re-enabling the cyclic de-bugging process.

However, existing solutions, such as the solution mentioned above, cannot guarantee accurate replay in existing record and replay tools. The solution does not guarantee accurate replay because the solution cannot solve the fundamental differences between the record and the replay functions. Therefore, there is a need for an accurate record and replay system to ensure that the replay of a recorded run is identical to that of the recorded run.

### SUMMARY

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Methods and systems for separating application processes into a system space and a replay space in a record and replay tool are described. Separation of space provides an accurate replay in the record and replay tool.

Space separation relies on the interception of API functions, or system calls (syscalls), within the record and replay tool. The concept of space separation allows for isolation of memory consumption of user code and avoids problems such as inconsistent memory footprints within the replay space, promoting accurate replay of code within the record and replay tool.

### BRIEF DESCRIPTION OF THE DRAWINGS

The detailed description is described with reference to the accompanying figures. In the figures, the left-most digit of a reference number identifies the figure in which the reference number first appears. The use of the same reference numbers in different figures indicates similar or identical items.

FIG. 1 illustrates a block diagram of an exemplary record and replay tool.

FIG. 2 illustrates a block diagram of a space separation according to FIG. 1.

FIG. 3 further illustrates a block diagram of the space separation according to FIG. 1.

FIG. 4 illustrates exemplary code templates according to FIG. 1.

FIG. 5 is a flow diagram that describes a process for generating a signal slot process according to one embodiment.

FIG. 5A illustrates an exemplary process according to FIG. 5.

FIG. 6 further illustrates a block diagram of the signal-slot process according to FIG. 1.

FIG. 7 illustrates a block diagram of an exemplary computing environment.

### DETAILED DESCRIPTION

### Overview

This disclosure is directed to techniques for space separation in a library based record and replay tool. This technique relies on the interception of API functions, or system calls (syscalls), within a record and replay tool. The concept of space separation allows for isolation of memory consumption of user code

### Exemplary Replay Tool

The following discussion of an exemplary system provides the reader with assistance in understanding ways in which various subject matter aspects of the system, methods, and computer program products may be employed. The system described below constitutes an example and is not intended to limit application of the subject matter to any a particular operating system.

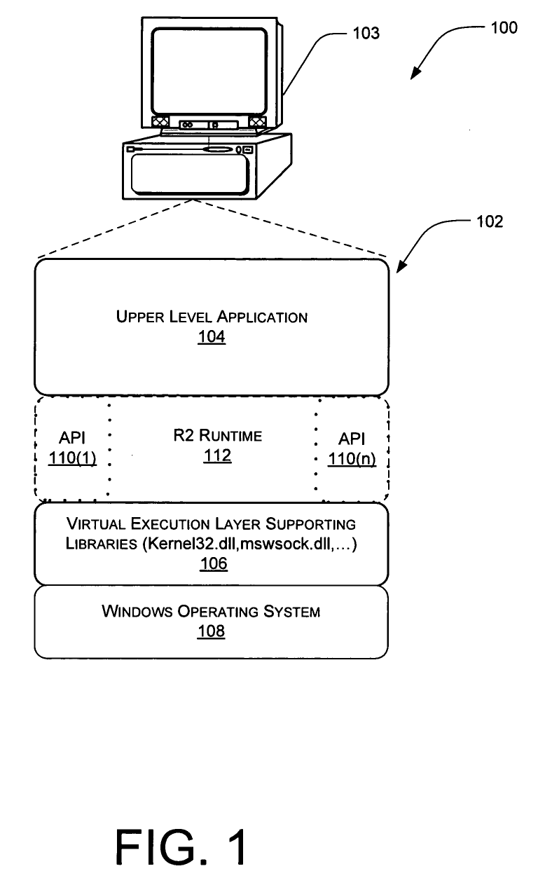

FIG. 1 is an overview block diagram of an exemplary system 100 including replay tool 102 and computing device 103. Computing devices 103 that are suitable for use with the system 100, include, but are not limited to, a personal computer, a laptop computer, a desktop computer, a digital camera, a personal digital assistance, a cellular phone, a video player, and other types of image sources. The replay tool 102 permits a deterministic simulation within a library based replay system, by which, a user may log pertinent information thereby ensuring that each input always produces the same output.

As depicted in the replay tool 102, there are upper application(s) 104 which communicate with the underlying library(ies) 106 and the operating system(s) 108 via a multitude of application program interface (API) functions 110(1)-110(n), also referred to as system calls. The system calls exist in what may be referred to as a R2 runtime 112. The R2 runtime 112 represents a natural boundary between the upper application 104 and the underlying supporting infrastructure including, without limitation, the library 106 and the operating system 108.

### Space Separation

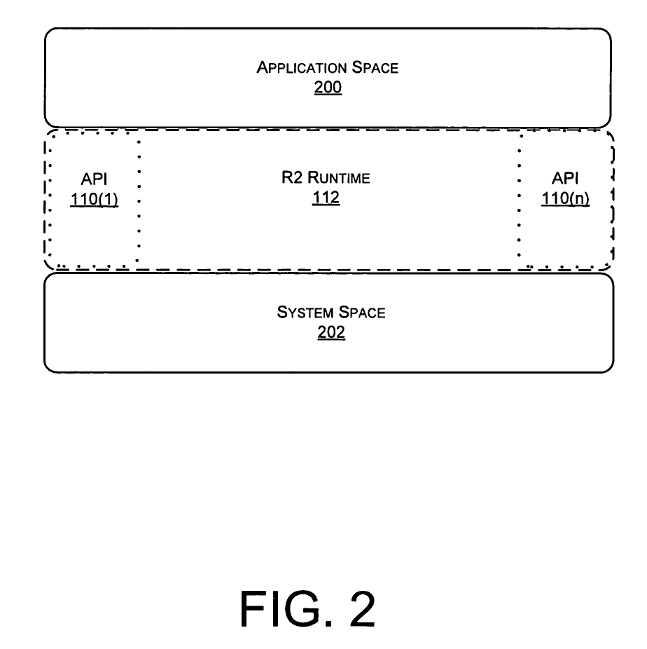

Inspired by the principle of isolation between kernel space and user space operating systems, as illustrated in FIG. 2, the replay tool 102 may be split into two distinct spaces, a replay or an application space 200 and a system space 202. Unlike isolation within operating systems however, the replay tool 102 permits developers to decide what the R2 runtime 112, or interface boundary, will be between the replay space 200 and the system space 202. This idea of space separation uses the interception of the API functions 110(1)-110(n), or system calls (syscalls), tightening the surface of what ought to be logged and replayed within the replay tool 102.

The concept of space separation allows for isolation of memory consumption of user code and avoids problems such as inconsistent memory footprints within replay space, promoting accurate replay of code within the replay tool 102. For example, memory allocation and release from both the application and replay tool can be interleaved in arbitrary ways. To circumvent such behavior, a dedicated heap manager for application space can be employed. This dedicated heap takes memory requests from application space, including the allocation of a thread stack, when a thread is in application space. Consequently, a thread created in application space inherently possesses a stack allocated from the application space heap. In addition, a stack is allocated from a system space heap for the application thread as well. Therefore, when an application thread invokes a syscall, the execution will be switched from the application stack to the system stack. Such a technique helps prevent replay tool 102 from being destroyed by bugs such as a buffer overflow from the target application.

FIG. 2 illustrates a block diagram of a space separation. In one embodiment, as illustrated in FIG. 2, the replay or the application space 200 is located above the R2 runtime 112, while sitting below the R2 runtime is the system space 202. All of the logic of the replay tool 102, including without limitation, logging and replaying, resides in the system space 202 along with the library 106 and the operating system 108. In addition, the system space 202 contains application code and data that is below the chosen syscall interface isolated in the R2 runtime 112. The replay or the application space 200 includes what is above the chosen syscall interface. In addition, the record and replay system maintains a replay/system mode bit to indicate whether the code should be executing in the application space 200 or the system space 202, and when necessary makes the transition between replay and system space.

### Choosing and Generating Syscalls and Upcalls

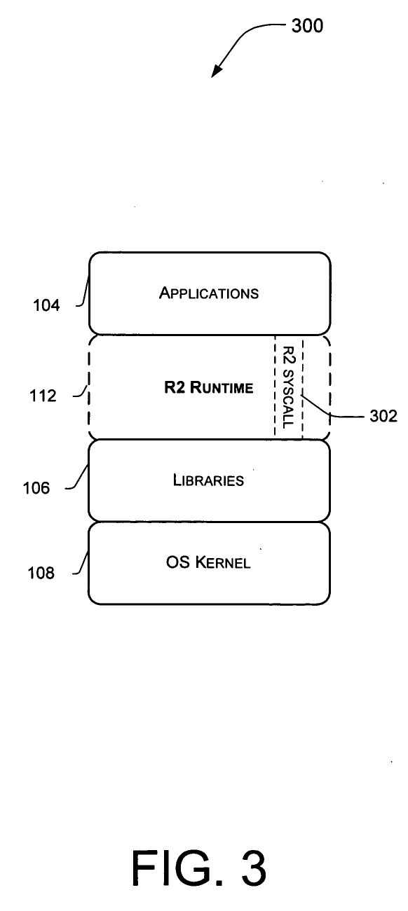

FIG. 3 further illustrates a block diagram of the space separation 300. A system call, or syscall, according to the computing device 103 is a request made by an arbitrary program to the operating system 108 for performing tasks. Most operations interacting with the system 108 require permission not available to a user level process, that is, any Input/Output (I/O) performed with any arbitrary device present on the system or any form of communication with other processes requires the use of syscalls 302. In one implementation, forming of the R2 runtime 112 allows the replay tool 102 to intercept and isolate the syscalls 302 using a technique referred to as a detour. For example, as illustrated in FIG. 3, the syscall 302 lies within the R2 runtime layer 112.

Following interception of the syscalls 302 the syscalls 302 are wrapped. A wrapper is an object that encapsulates and delegates to another object, with the aim of altering the objects behavior or interface. In one implementation, a wrapped syscall (and or upcall) may be referred to as a stub. In another implementation, a wrapped syscall may be referred to as a wrapped API function.

The recording and replay of the syscall 302 and the upcall stubs ensure accurate replay within the replay tool 102. For example, the creation of a syscall stub instigates the recording of that syscall stub along with a correlating timestamp. The creation of an upcall also instigates not only the recording of a correlating timestamp, but also a callback function pointer, and any arguments related to the specific upcall. During replay, the replay tool 102 replays syscalls 302 and upcalls according to their recorded timestamps. For syscalls 302, a syscall stub reads the recorded result values from the log and returns those instead of invoking the syscall 302. For upcalls, the replay tool 102 invokes an upcall with the function pointer and recorded arguments from the log.

For replay to be accurate, the chosen syscall 302 must follow at least, without limitation, two rules: 1) isolation of any variable that is a read variable and a write variable should either be entirely enclosed by syscalls or outside of any syscall, and 2) non-determinism, wherein any source of non-determinism should be enclosed by a syscall.

Use of the isolation rule will eliminate any shared states between application 200 and system space 202. For example, a variable enclosed by a syscall 302 will be invisible to the replay space. The syscall belongs to system space 202 and is therefore outside of the debugging scope of a developer. A variable outside of a syscall 302 will be accurately replayed by re-executing all of the operations encompassed within the variable. Typically, violation of the isolation rule will cause the record/replay system to fail.

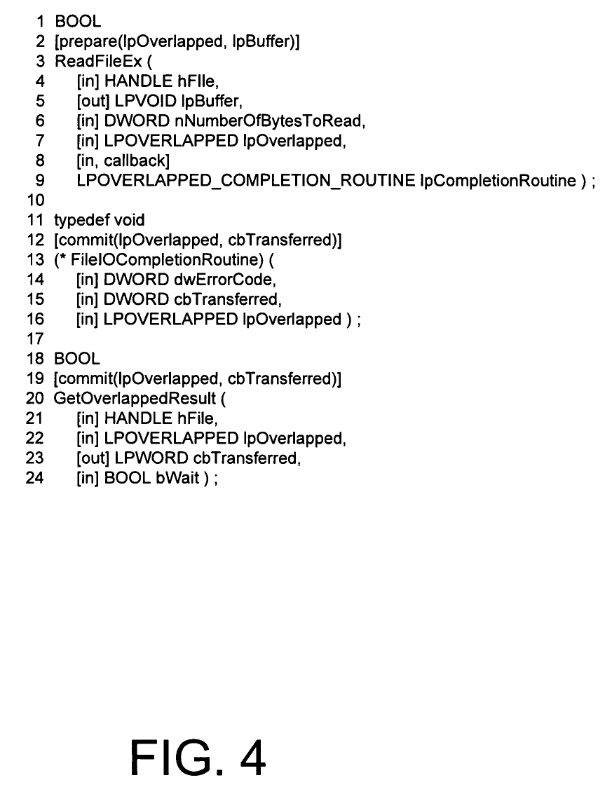

FIG. 4 illustrates exemplary code templates according to FIG. 1. FIG. 4 provides an overview of how stubs are generated for the read existing kernel system calls. Win32 prototypes already has annotations such as in and out, which the replay tool 102 reuses to understand in what direction data must be copied in the stub for read. In one implementation, forming of the R2 runtime 112 allows the replay tool 102 to intercept and to isolate the syscall 302 using a technique referred to as a detour. However, in alternative implementations other techniques may be used to intercept and to isolate the syscall 302 functions.

The detour is a library for intercepting functions. The detour may operate by replacing the first few instructions of the target function with a jump to the user-provided detour function. Detours are typically inserted at the time of execution. The code of a target function is modified in memory, not on a disk, therefore permitting interception of the API functions or syscalls 110(1)-(n) at a very fine level. For example, the procedures in a dynamic link library (DLL) can be detoured in an execution of an application, while the original procedures are not detoured in another execution running at the same time. In general, techniques used in the detour library work regardless of the method used by the application 102 or system code to locate the target function.

In one implementation, the annotations for data transfers reside in one of at least three categories, direction annotations, buffer annotations, and asynchrony annotations. However, in other implementations, there may be more than three categories. Direction annotations define a source and a destination of a data transfer. Examples shown in FIG. 4 include, without limitation, in of fd and count (line 4) means that they are read-only and transfer data into function read, while out on buffer (line 6) indicates that read fills a memory region at buffer and transfers data out of the function.

### Generating a Signal-Slot

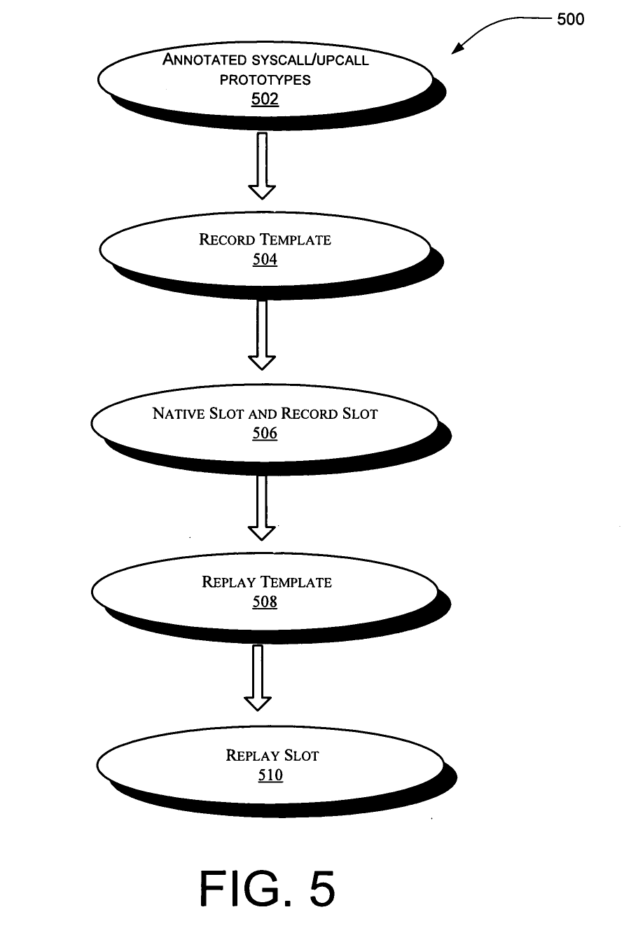

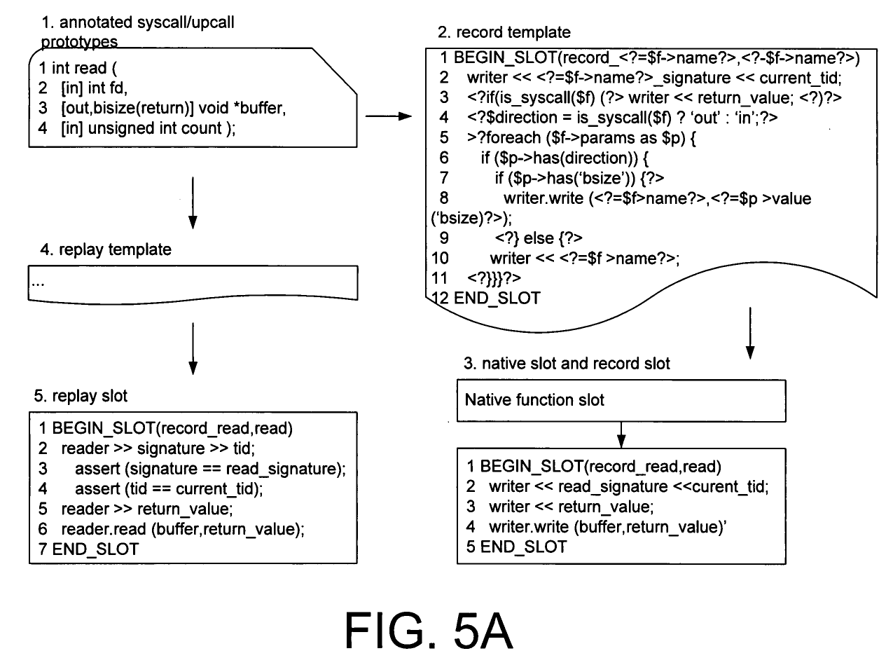

FIG. 5 illustrates a flow diagram 500 for a generation of a signal-slot process according to FIG. 1. For ease of understanding, the method 500 is delineated as separate steps. However, these separately delineated steps should not be construed as necessarily order dependent in their performance. The order in which the process is described is not intended to be construed as a limitation, and any number of the described process blocks may be combined in any order to implement the method, or an alternate method. Moreover, it is also possible that one or more of the provided steps may be omitted.

In 502, developers may use keywords to prepare and to annotate the syscall or the upcall. In one implementation, a recording mode permits the annotated upcall or syscall to be converted into a record slot in 506 using the code template for recording in 504, and this record slot is placed after the native slot of the function which represents the native implementation of the function. In another implementation, a replay mode permits the annotated upcall or syscall to be converted into a replay slot in 510 using the code template for replay in 508.

FIG. 5A illustrates the process 500 in more detail. For example, ReadfileEx issues an asynchronous input/output (I/O) request keyed by lpOverlapped, which is called a request key. Developers use keywords to prepare and to annotate the syscall as shown in 502 with the request key and the associated buffer lpbuffer. The completion of the request will be notified either as an upcall to FileIoCompletionRoutine or via a syscall to GetOverlappedResult, when the associated buffer has been filled in system space. In either case, developers use the keyword commit to annotate with the request key and transferred data size cbTransferred. Replay tool 102 can then match the buffer lpbuffer with its size cbTransferred via the request key for record and replay.

Some syscalls allocate a buffer in system space and the application may use the buffer in application space. Buffer annotations define how the replay tool 102 should serialize and de-serialize data being transferred for record and replay. Asynchrony annotations define asynchronous data transfers that finish in two calls rather than in one. For example, as illustrated in FIG. 5, ReadfileEx issues an asynchronous input/output (I/O) request keyed by lpOverlapped, which is called a request key. Replay tool 102 provides keywords, such as, xpointer annotate this buffer, and will allocate a shadow buffer in replay space for the application, at both record and replay time. Data is copied to the shadow buffer from the real buffer in system space during recording, and from logs during replay.

Replay tool 102 uses the code templates to process the annotated syscall/upcall prototypes at 502, and generates slot code for record and replay. FIG. 5 illustrates the code template and the final code snippet for function read.

Replay tool 102 uses the record template shown at 504 for most syscalls and upcalls. It logs all the data transmitted from the replay tool 102 system space to the replay tool 102 replay space. The code template will generate code for recording the return value only when processing the replay tool 102 syscalls. When scanning the parameters, it will record the data transfer according to the event type and annotated direction keywords. Specifically for the upcalls, the input parameters and upcall function pointers are recorded so that the replay tool 102 during replay executes the same callback with the same parameters.

### Exemplary Use of Replay Tool

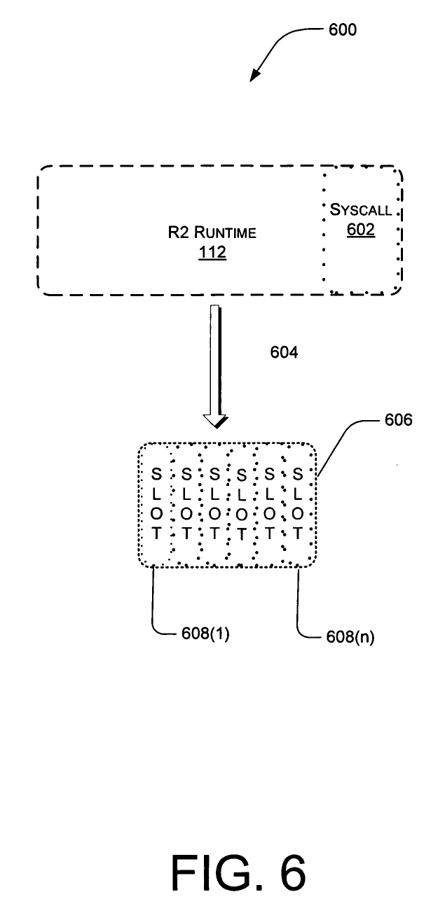

FIG. 6 further illustrates a block diagram of the signal-slot process 600 according to FIG. 1. As shown in FIG. 6, the wrapped syscall 602 takes charge of dispatching the execution into the correct subspace, that is, either the application space 200 or the system space 202. In addition, the wrapped syscall 602 directs the execution of thread 604 into the signal-slot process 606. In addition, as shown in FIG. 6, the signal-slot process 606 includes slots 608(1)-608(n). In one implementation, slots 608(1)-608(n) are also generated by way of the same annotation information used to generate the code wrapper discussed above. In alternative implementations, the slots may be generated by using a different method. The generated slots may also be referred to as snippets.

Typically, the execution of the thread is viewed as a succession of three types of events. Those three events include, without limitation, an API event, a continuation event, and a callback event (upcall). The API event is the invocation of the intercepted syscall 602. The API event segments the thread execution into the continuation events. Some of these syscalls can take callback routines that will be executed at some future points, and their invocations are the callback events.

A multi-threaded, distributed application is a collection of these three events from the various events running on the distributed computing devices. The task of logging these events includes at least two approaches. First, numbering of the events, and second, recording the output of the API events such that the replay tool 102 can process these events in increasing order while feeding the outputs of the API events from the log. This ensures that the internal state of the application can be accurately recreated as dictated by the application logic.

The events are numbered by assigning each event a 64-bit integer that referred to as a logical clock. Logical clocks are assigned within a process, without limitation, by one of at least two approaches. First, logical clocks are assigned through the use of a customized scheduler which defines scheduling points at the boundary of the intercepted syscall 302. The second approach begins with each thread inheriting a logical clock from the threads creator. The logical clock is then modified to reflect the relationship among events by capturing the relationship between the various API events that access the same resource. A shadow memory block is allocated behind each resource such that the shadow block may store, without limitation, the thread ID and the logical clock of the last API event that accessed the resource. When the API event accesses a resource a corresponding logical clock is updated with the maximum of either API events own clock or that of the last logical clock value recorded on the shadow memory block, therefore processing events in the order as determined by the logical clock.

Logical clock values may also be assigned across processes using a layered service provider. The layered service provider implements only higher-level communication functions while relying on an underlying transport stack for the actual exchange of data with a remote endpoint. Such communication may, for example and without limitation, take place by transferring messages through the use of a socket. The socket is an identifier for a particular service on a particular node of a network. The socket includes a node address and a part number, identifying the service. The layered service provider will build a filter and message processing layer. The socket based messages with travel through this layer, whereby a logical clock is embedded in the outgoing message and extracted as it enters. Such a process is transparent to the application.

### Exemplary Process for Record and Replay

In one embodiment, a record and replay process is initiated when a user invokes record and replay with the application to be recorded using the replay tool 102. The initial thread of the process begins inside in the system space by loading the application's executable and treating the main entry as an upcall (i.e., the main function is turned into an upcall by generating an upcall stub). The stub sets the replay/system mode bit to the application, switches to a stack allocated in replay space, and invokes main. Replay tool 102 allocates a new stack in replay space to ensure that the memory addresses of local variables are the same during replay as during the corresponding recorded run. Replay tool 102 assigns the thread a deterministic tag, and the stub also records the thread tag that the stub is using.

When the code is in replay space the code invokes a syscall, the syscall stub sets the replay/system mode to system, invokes the syscall, records the results, and restores the mode bit. Similarly, when the code in system space invokes a upcall, the stub sets the mode bit to application, records the arguments, invokes the upcall, and restores the mode bit.

Because replay tool 102 records and replays only syscalls and upcalls, handling anonymous threads created in system space during recording is simple, the replay tool 102 does not maintain state about individual threads, keeping track of syscalls and upcalls a thread makes. For example, for anonymous threads that do not interact with replay space, it is safe to ignore anonymous threads during recording. If the thread performs an upcall, then the stub will be recorded and the thread enters replay space, similar to the initial thread example. Since the replay tool 102 records the execution only in replay space, carefully controlling a transition between the two spaces to make replay accurate. Particularly, the execution of anonymous threads that are not created by the application are filtered out by isolating the anonymous threads in system space.

### Exemplary Computing Environment

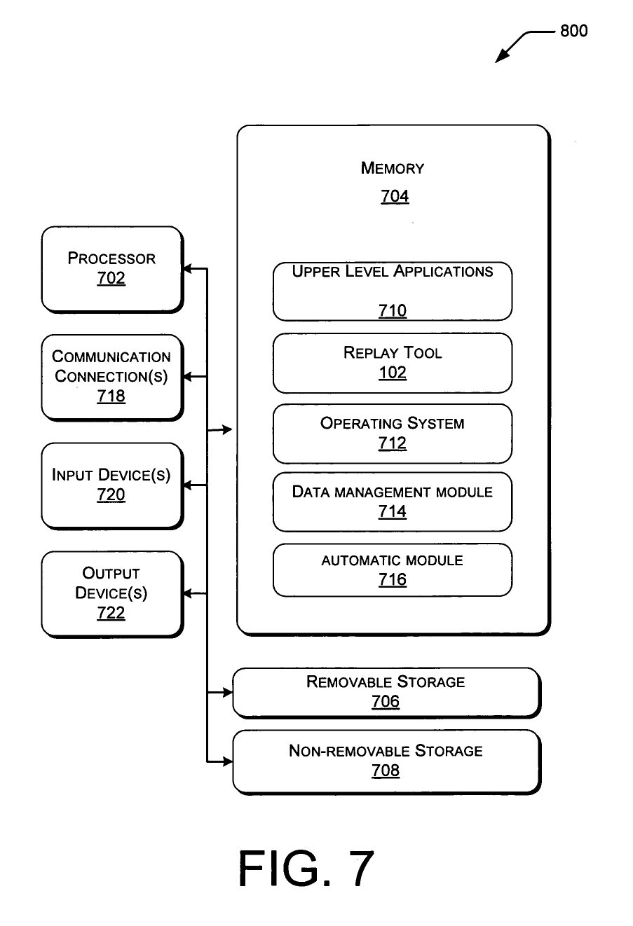

FIG. 7 is a schematic block diagram of an exemplary general operating system 700. The system 700 may be configured as any suitable system capable of implementing the replay tool 102. In one exemplary configuration, the system comprises at least one processor 702 and memory 704. The processing unit 702 may be implemented as appropriate in hardware, software, firmware, or combinations thereof. Software or firmware implementations of the processing unit 702 may include computer- or machine-executable instructions written in any suitable programming language to perform the various functions described.

Memory 704 may store programs of instructions that are loadable and executable on the processor 702, as well as data generated during the execution of these programs. Depending on the configuration and type of computing device, memory 704 may be volatile (such as RAM) and/or non-volatile (such as ROM, flash memory, etc.). The system may also include additional removable storage 706 and/or non-removable storage 708 including, but not limited to, magnetic storage, optical disks, and/or tape storage. The disk drives and their associated computer-readable medium may provide non-volatile storage of computer readable instructions, data structures, program modules, and other data for the communication devices.

Memory 704, removable storage 706, and non-removable storage 708 are all examples of the computer storage medium. Additional types of computer storage medium that may be present include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by the computing device 103.

Turning to the contents of the memory 704 in more detail, may include an upper level application 710, an operating system 712, one or more replay tools 102. For example, the system 700 illustrates architecture of these components residing on one system or one server. Alternatively, these components may reside in multiple other locations, servers, or systems. For instance, all of the components may exist on a client side. Furthermore, two or more of the illustrated components may combine to form a single component at a single location.

In one implementation, the memory 704 includes the replay tool 102, a data management module 714, and an automatic module 716. The data management module 714 stores and manages storage of information, such as images, ROI, equations, and the like, and may communicate with one or more local and/or remote databases or services. The automatic module 716 allows the process to operate without human intervention.

The system 700 may also contain communications connection(s) 718 that allow processor 702 to communicate with servers, the user terminals, and/or other devices on a network. Communications connection(s) 718 is an example of communication medium. Communication medium typically embodies computer readable instructions, data structures, and program modules. By way of example, and not limitation, communication medium includes wired media such as a wired network or direct-wired connection, and wireless media such as acoustic, RF, infrared and other wireless media. The term computer readable medium as used herein includes both storage medium and communication medium.

The system 700 may also include input device(s) 720 such as a keyboard, mouse, pen, voice input device, touch input device, etc., and output device(s) 722, such as a display, speakers, printer, etc. The system 700 may include a database hosted on the processor 702. All these devices are well known in the art and need not be discussed at length here.

### CONCLUSION

Although embodiments for space separation have been described in language specific to structural features and/or methods, it is to be understood that the subject of the appended claims are not necessarily limited to the specific features or methods described. Rather, the specific features and methods are disclosed as exemplary implementations.

What is claimed is:

1. A system comprising:
a memory;
a processor coupled to the memory;
a runtime layer stored in the memory;
a first layer in communication with a second layer via the runtime layer, wherein the first layer is an application space layer and the second layer is a system space layer.

2. The system of claim 1, wherein the system space layer comprises an operating system and a library.

3. The system of claim 2, wherein the system space further comprises a replay tool and a logging tool.

4. The system of claim 1, wherein the application space layer comprises hosting a target application and requesting memory from a dedicated memory manager.

5. The system of claim 4, wherein the dedicated memory manager comprises locating in the system space layer.

6. The system of claim 1, further comprising one or more application program interface (API) functions existing in the runtime layer, wherein the API functions facilitate communication between the first layer and the second layer.

7. A method comprising:
creating an initial thread in a first space of a record and replay tool;
treating the initial thread as an upcall;
generating a stub for the upcall, wherein the stub sets a mode bit to signify an initial space; and
recording the stub in an initial dedicated memory manager located within the initial space.

8. The method of claim 7, further comprising invoking a syscall, wherein the invoking of the syscall sets the mode bit to signify another space.

9. The method of claim 8, further comprising recording the results of the syscall and restoring the mode bit to the initial space.

10. The method of claim 7, wherein the another space comprises an underlying infrastructure and a trusted space.

11. The method of claim 10, wherein the another space further comprises a another dedicated memory manager.

12. The method of claim 7, further comprises isolating the syscall in a intermediate space, wherein the intermediate space acts as a natural boundary between the initial space and the another space.

13. The method of claim 12, wherein a intermediate space comprises an entry point and a return point of the isolated syscall.

14. One or more computer-readable storage media containing instructions that are executable by a computing device to perform actions comprising:
signifying stubs within a first space or a second space around syscalls or upcalls;
creating a first dedicated memory manager for the first space; and
creating a second dedicated memory manager for the second space.

15. The one or more computer-readable storage media of claim 14, wherein the first dedicated memory manager comprises taking a memory request from a thread existing in the first space.

16. The one or more computer-readable storage media of claim 14, wherein the second dedicated memory manager comprises taking a memory request from a thread existing in the second space.

17. The one or more computer-readable storage media of claim 14, wherein the first space comprises an application space, wherein the application space hosts the target application.

18. The one or more computer-readable storage media of claim 17, wherein the application space comprises a replay of the target application.

19. The one or more computer-readable storage media of claim 14, wherein the second space comprises a system space, wherein the system space comprises at least one of a supporting library or an operating system.

20. The one or more computer-readable storage media of claim 19, wherein the system space further comprises a replay tool and a logging tool.
